(19) United States
(12) Patent Application Publication
(10) Pub. No.: US 2019/0174845 A1
(43) Pub. Date: Jun. 13, 2019

(54) PROTECTIVE MASK WITH EMBEDDED NOSE PAD

(71) Applicant: CENTER HEALTHCARE TECHNOLOGY CO., LTD., TAIPEI CITY (TW)

(72) Inventors: Yung-Chu CHENG, TAIPEI CITY (TW); Chien-Feng CHENG, TAIPEI CITY (TW); Yu-Liang CHENG, TAIPEI CITY (TW)

(21) Appl. No.: 16/321,909

(22) PCT Filed: Sep. 1, 2017
(86) PCT No.: PCT/CN2017/100124

§ 371 Date: Jan. 30, 2019

(30) Foreign Application Priority Data
Sep. 12, 2016 (CN) 201610814439.7

(51) Int. Cl. A41D 13/11; A62B 18/02

(52) U.S. Cl. CPC A41D 13/1107; A62B 18/02

(57) ABSTRACT

A face mask having an embedded nose pad, including: a mask body having an outer layer, a middle layer, and an inner layer sequentially; and a nose pad disposed on the outer layer, wherein the inner layer extends and doubles back to form an inner layer flap, and the nose pad is enclosed by the inner layer flap and the outer layer jointly, allowing a raised portion to be formed on the mask body and corresponding in position to the nose pad. Hence, the face mask effectively prevents users from inhaling unfiltered air and stops exhaled moisture from rising through the mask body, thereby not only precluding a leak through the nasal portion of the face mask but also preventing eyeglasses from fogging.

### BACKGROUND OF THE INVENTION

### 1. Field of the Invention

The present invention relates to face masks and, more particularly, to a face mask having an embedded nose pad.

### 2. Description of the Prior Art

The world nowadays features rapid industrialization and urbanization, and in consequence various plants, coal-fired power plants, automobiles, and motorcycles emit exhaust gas and thus cause severe air pollution, leading to deterioration of air quality. For example, PM2.5 suspended in air travel deeply into the human respiratory tract, causing various diseases, such as bronchitis, asthma, and cardiovascular diseases, to the detriment of human health. In 2013, the World Health Organization (WHO) classified outdoor air pollution as a leading environmental cause of cancer. In Taiwan, seven of the 10 most common cancers are closely related to air pollution. Furthermore, public health is recently at risk, as a result of diseases caused by bacteria and virus, such as SARS epidemic, bird flu, and swine flu (H1N1). In the face of the aforesaid health issues, human beings are attaching more importance to face masks.

At present, the number of face masks used annually worldwide is estimated at tens of billions, and around 80% of them are flat non-woven fabric face masks. Although commercially-available flat face masks, and even some N95 respirators, are portable and cheap, they are poor in airtightness. Under related Taiwan's standards, CNS14774 and 14755, which govern a respirator (N95/FFP2) D2 airtightness measurement method, when worn by a user, a good respirator must achieve airtightness 100 (100%÷100 airtightness=1% leak rate). A test conducted on 100 humans by Taiwan's Institute of Labor, Occupational Safety and Health, reveals that two commercially-available N95 masks achieve average airtightness of 13.9 and 21.8 respectively. By contrast, the test reveals that ordinary face masks achieve average airtightness of 3.10 and thus average leak rate of 33%, showing that ordinary face masks are not effective in blocking PM2.5. To maintain a certain degree of airtightness, every conventional face mask comes with a plastic nosepiece at its upper side. The plastic nosepiece is provided in the form of a plastic strip or in the form of an iron or aluminum wire encased in a plastic sheath to enhance airtightness by closing the gap between the user's nose and cheeks. However, the nasal portion of the face mask is mostly likely predisposed to a leak and most difficult to prevent the leak, because of the shape and size of the nose and the nasal bridge height. Minutes after the user has pressed the nosepiece of the face mask by hand to fit the upper side of the face mask to the contour of the nose, a considerable gap between the user's nose and cheeks is formed as a result of even mild facial muscular movement. Furthermore, the lateral sides of the face mask are likely to admit airborne pollutants, bacterial and virus, because the lateral sides of the face mask are attached to the user's ears by straps or elastic earloops. These problems with the conventional face masks remain unsolved.

Without wearing a face mask with a view to filtering out air pollutants, people are more likely to have cancers and the other related chronic diseases, such as hypertension and diabetes, or even die of complications therefrom. Moreover, without wearing the face mask, people in the hospital or public spaces are more likely to be susceptible to cross infections and thus higher incidence rates. In addition, when worn by a user, the conventional face mask is usually attached to the user's mouth and nose, i.e., the two sites of air exchange, and in consequence the resistance to respiration increases, expelling more air from the gap between the nose and cheeks, hence, this is the main reason why the leak rate is usually around 40%. The higher the leak rate is, the more likely the user is exposed to the aforesaid health hazards. These are the reasons why the defects of the conventional non-woven fabric face masks have existed for decades and remained unsolved.

Furthermore, the warm air exhaled from a user wearing a face mask rises and escapes from the gap between the nasal bridge and the top side of the face mask to therefore fog the user's eyeglasses and block the user's vision, thereby compromising the safety of the user if the user is walking or driving. In addition, a commercially-available cushioning nose foam for face mask fails to demonstrate satisfactory airtightness at the nasal portion of the face mask, as the face mask cannot be fitted to the contour of the user's nasal bridge and cheekbones; it is because the nose foam is kind of thick and disposed between the face mask and the nasal bridge, and in consequence gaps are likely to form between the face mask and the foam and between the face mask and the cheeks.

### SUMMARY OF THE INVENTION

In view of this, the first objective of the present invention is to provide a face mask having an embedded nose pad, with a raised portion formed at the upper side of a mask body such that an inner layer can be fitted to the contour of the nasal bridge and the cheekbones to thereby effectively fill the gap between the face mask and the nose, greatly enhance the airtightness of the face mask.

The second objective of the present invention is to provide a face mask having an embedded nose pad, characterized in that a mask body comprises horizontal and vertical folds so that the mask body is stretched to become three-dimensional, so as to increase the inner breathing space and air exchange area, allowing the user to breathe smoothly, speak naturally, and reduce the resistance to respiration greatly.

The third objective of the present invention is to provide a face mask having an embedded nose pad, with a raised portion formed at the upper side of a mask body to fill the gap between the nasal bridge and each cheekbone, so as to block and prevent exhaled moisture from rising through the mask body, thereby preventing eyeglasses from fogging.

In order to achieve the above and other objectives, the present invention provides a face mask having an embedded nose pad, comprising: a mask body having an outer layer, a middle layer, and an inner layer sequentially; and a nose pad disposed on the outer layer, wherein the inner layer extends and doubles back to form an inner layer flap, and the nose pad is enclosed by the inner layer flap and the outer layer jointly, allowing a raised portion to be formed on the mask body and corresponding in position to the nose pad.

Preferably, the face mask further comprises a plurality of fixing portions arranged along an edge of the raised portion and adapted to fix the inner layer flap, the outer layer, the middle layer, and the inner layer in place.

Preferably, the middle layer is a filter layer, and the raised portion is formed on the filter layer.

Preferably, the outer layer extends and doubles back to form an outer layer flap such that the outer layer flap is superimposed on the inner layer flap to enclose the nose pad together with the outer layer.

Preferably, the mask body comprises two vertical folds which flank the nose pad.

Preferably, the face mask has two bending parts extending from two lateral sides of the mask body respectively, and doubling back to get fixed two ends to the mask body.

Preferably, the face mask further comprises an inner fogproof plate fixed to the inner layer and having the raised portion.

Preferably, the face mask further comprises an exhalation valve mounted on the mask body.

Preferably, the face mask further comprises an activated carbon layer sandwiched between the outer layer and the middle layer.

Preferably, the face mask further comprises an antiviral layer superimposed on the outer layer or sandwiched between the outer layer and the middle layer.

Preferably, the nose pad is a foam or a combination of a nosepiece and a foam.

The present invention further has features and advantages as follows:

1. Bending parts extend from the lateral sides of the mask body respectively, to fill or close the gap between the face mask and each cheek, greatly enhance the airtightness of the face mask.

2. A fogproof plate is fixed to the upper side of the inner layer or inner layer flap to further block and prevent exhaled moisture from rising through the mask body, thereby precluding the fogging of eyeglasses or the blocking of vision.

3. An exhalation valve is mounted on the mask body. The exhalation valve enables the user to discharge moisture and heat quickly during exhalation, keep the face mask cool, discharge exhaled air quickly when taking vigorous exercise or suffering shortness of breath, and reduce the resistance to exhalation greatly.

4. The mask body further has therein an antiviral layer which reduces the activity of viruses and bacteria and inhibits their growth, thereby being effective in killing viruses and bacteria and preventing infections.

5. The mask body further has therein an activated carbon layer which is effective in adsorbing ozone and organic gases.

### BRIEF DESCRIPTION OF THE DRAWINGS

FIG. 1 is a front view of a face mask having an embedded nose pad according to the present invention (the 1^{st} preferred embodiment);

FIG. 2 is a cross-sectional view taken along line A-A of FIG. 1;

FIG. 3 is a front view of the face mask which extends to form bending parts (the 2^{nd} preferred embodiment);

FIG. 4 is a cross-sectional view taken along line B-B of FIG. 3;

FIG. 5 is a front view of the face mask which comprises vertical folds (the 3^{rd} preferred embodiment);

FIG. 6 is a cross-sectional view taken along line C-C of FIG. 5;

FIG. 7 is a front view of the face mask which comprises bending parts and vertical folds (the 4^{th} preferred embodiment);

FIG. 8 is a front view of the face mask which comprises an exhalation valve (the 5^{th} preferred embodiment);

FIG. 9 is a cross-sectional view of the face mask which comprises an inner fogproof plate (the 6^{th} preferred embodiment);

FIG. 10 is a cross-sectional view of the face mask which comprises an outer fogproof plate (the 7^{th} preferred embodiment);

FIG. 11 is a cross-sectional view of the face mask which extends to form an outer layer flap (the 8^{th} preferred embodiment);

FIG. 12 is a cross-sectional view of the face mask which extends to form a middle layer flap (the 9^{th} preferred embodiment);

FIG. 13 is a front view of the face mask with a nose pad disposed at the upper side of the face mask (the 10^{th} preferred embodiment);

FIG. 14 is a front view of the face mask with a nosepiece of a length approximately half of the length of an elastomer (the 11^{th} preferred embodiment);

FIG. 15 is a cross-sectional view of the face mask which comprises an activated carbon layer (the 12^{th} preferred embodiment);

FIG. 16 is a cross-sectional view of the face mask which comprises the activated carbon layer and extends to form an outer layer flap (the 13^{th} preferred embodiment);

FIG. 17 is a cross-sectional view of the face mask with an outer layer, a middle layer, and an antiviral layer disposed therebetween (the 14^{th} preferred embodiment);

FIG. 18 is a cross-sectional view of the face mask with the antiviral layer disposed on the outer layer (the 15^{th} preferred embodiment);

FIG. 19 is a cross-sectional view of the face mask with the nosepiece embedded in the elastomer (the 16^{th} preferred embodiment);

FIG. 20 is a cross-sectional view of the face mask with an iron wire provided in the form of a single iron wire (the 17^{th} preferred embodiment);

FIG. 21 is a front view of the face mask with the nose pad disposed at the lower side of the mask body (the 18^{th} preferred embodiment);

FIG. 22 is a front view of the face mask with the nose pads disposed at two lateral sides of the mask body (the 19^{th} preferred embodiment); and

FIG. 23 is a front view of the face mask with the nose pads disposed at two lateral sides and the lower side of the mask body (the 20^{th} preferred embodiment).

### DETAILED DESCRIPTION OF THE EMBODIMENT OF THE INVENTION

The technical features of the present invention are illustrated with drawings and described below. However, the drawings are illustrative rather than restrictive of the present invention.

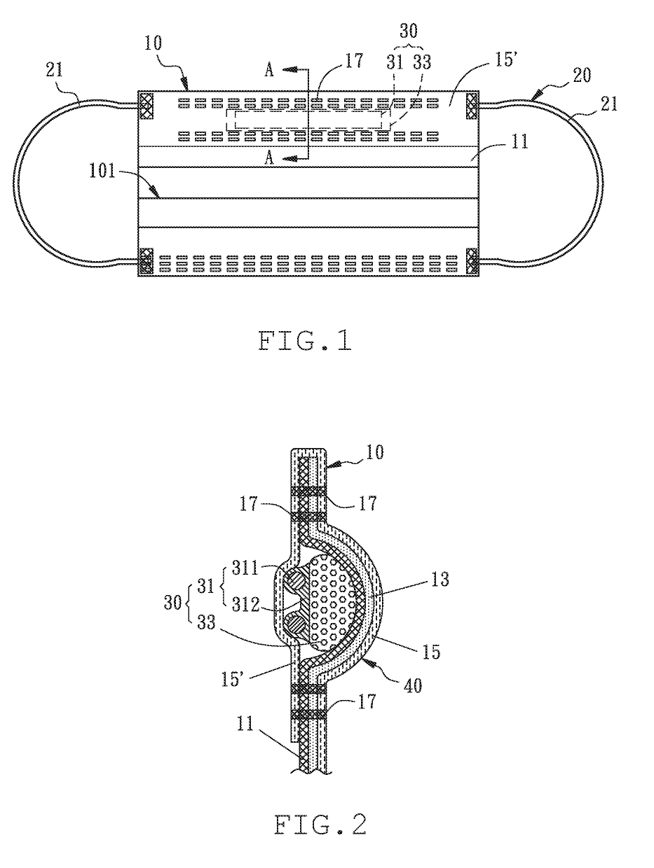

Referring to FIG. 1 and FIG. 2, the present invention provides a face mask having an embedded nose pad. The face mask comprises a mask body 10, a band set 20, and a nose pad 30.

The mask body 10 comprises a plurality of horizontal folds 101, the mask body 10 having therein an outer layer 11, a middle layer 13, and an inner layer 15 sequentially. The outer layer 11 is a water repellent layer made of water repellent non-woven fabric, for example, for preventing water and liquid from seeping in. The middle layer 13 is a filtration layer made of electrostatic high-density non-woven, for example, for blocking dust, virus, and bacteria. The inner layer 15 is a water absorbent layer made of micro-fibered non-woven and thus is soft, comfortable, and effective in absorbing moisture.

The band set 20 comprises two bands 21 which are earloops and fixed to the left and right sides of the mask body 10 respectively. Each band 21 has one end fixed to the upper side of the mask body 10 and the other end fixed to the lower side of the mask body 10 (as shown in FIG. 1). Alternatively, the bands 21 are straps or head-wearing bands, but the present invention is not limited thereto.

The nose pad 30 is disposed on the outer layer 11 (as shown in FIG. 2). The nose pad 30 comprises a nosepiece 31 and an elastomer 33. The nosepiece 31 comprises a plastic element 312 and an iron wire 311 enclosed by the plastic element 312. The iron wire 311 is provided in the number of two. The nosepiece 31 is affixed to one side of the elastomer 33. The elastomer 33 is any type of foam, such as PU foam, silicone foam, rubber foam, filter foam, memory foam, plastic plate, or airbag, and its cross section is round, rectangular, triangular, or polygonal, but the present invention is not limited thereto. Alternatively, the nose pad 30 comprises only the elastomer 33 or foam.

The inner layer 15 extends and bends over to form an inner layer flap 15′. The inner layer flap 15′ and the outer layer 11 jointly enclose the nose pad 30 and form a raised portion 40 on the mask body 10 and corresponding in position to the nose pad 30. Hence, the outer layer 11, the middle layer 13 and the inner layer 15 jointly form thereon the raised portion 40.

The mask body 10 further comprises a plurality of fixing portions 17 arranged along the edge of the raised portion 40. Each fixing portion 17 fixes the inner layer flap 15′, the outer layer 11, the middle layer 13, and the inner layer 15 in place. Before each fixing portion 17 fixes the inner layer flap 15′, the outer layer 11, the middle layer 13, and the inner layer 15 in place, both the nose pad 30 and the mask body 10 are pressed and put into the cavity, and then they get fixed to the mask body 10 by the fixing portions 17 to form the raised portion 40.

To wear the face mask of the present invention, a user wears the two earloops or strap bands 21, spreads apart the horizontal folds 101 to thereby cover the mouth, nose, and chin with the mask body 10 fully, adjust and press the nose pad 30. Due to the raised portion 40, the inner layer 15 can be fitted to the contour of the nasal bridge and the cheekbones to thereby effectively fill the gap between the face mask and the nose, greatly enhance the airtightness of the face mask.

The gap between the nose and each cheekbone is filled with the raised portion 40 formed on the upper side of the mask body 10 to block and prevent exhaled moisture from rising through the mask body 10, thereby preventing eyeglasses from fogging.

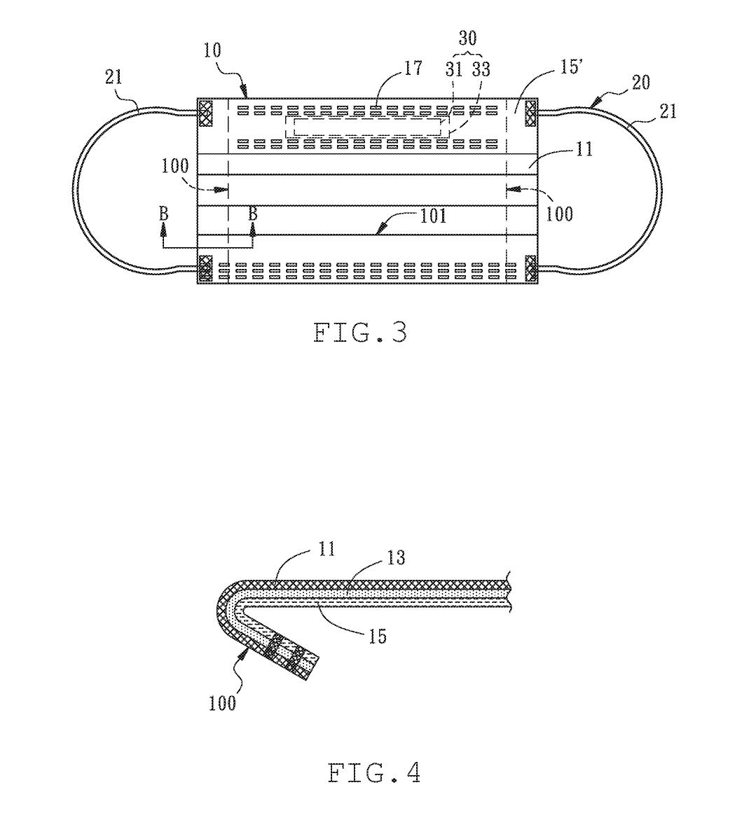

Referring to FIG. 3 and FIG. 4, there are shown diagrams illustrative of the 2^{nd} preferred embodiment of the present invention. This embodiment is distinguished from the preceding embodiment by technical features as follows: two bending parts 100 extend from the two lateral sides of the mask body 10 respectively, and double back to get fixed two ends to the mask body 10; and the bending parts 100 fill or close the gap between the face mask and each cheek, greatly enhance the airtightness of the face mask.

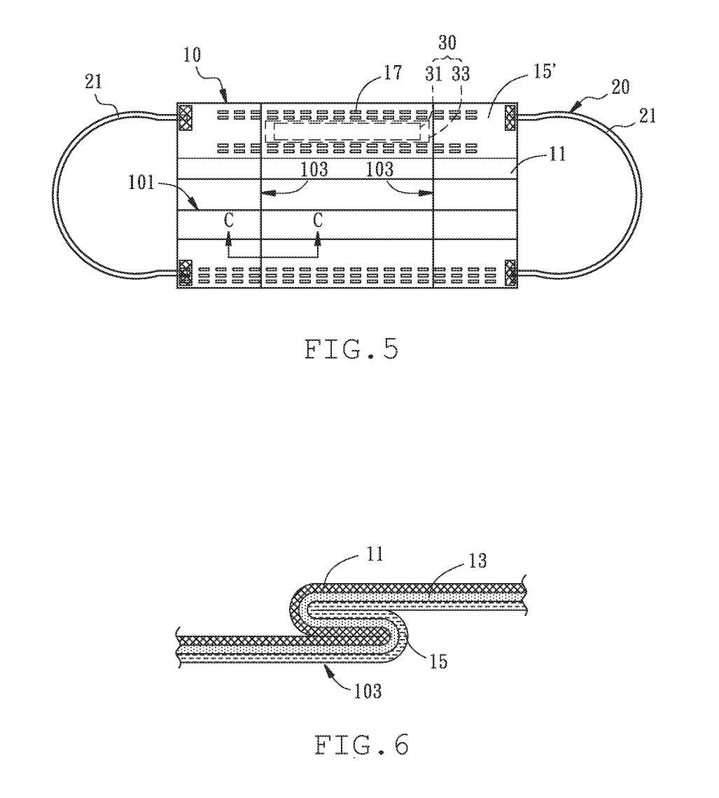

Referring to FIG. 5 and FIG. 6, there are shown diagrams illustrative of the 3^{rd} preferred embodiment of the present invention. This embodiment is distinguished from the preceding embodiments by a technical feature as follows: the mask body 10 comprises at least two vertical folds 103 which flank the nose pad 30 laterally and cross the horizontal folds 101 respectively. Hence, the mask body 10 is stretched to become three-dimensional, so as to increase the inner space and air exchange area. Therefore, the user can breathe smoothly, speak naturally, and reduce the resistance to respiration greatly.

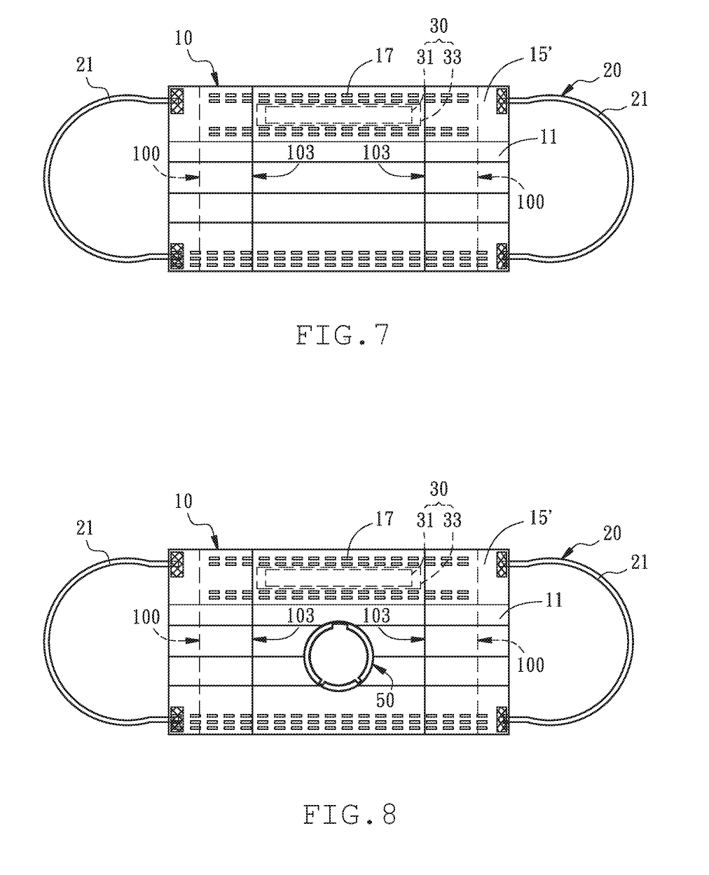

Referring to FIG. 7, there is shown a diagram of the 4^{th} preferred embodiment of the present invention. This embodiment is distinguished from the preceding embodiments by a technical feature as follows: the mask body 10 comprises the bending parts 100 and the vertical folds 103 which have the same functions and advantages as described above. Furthermore, the face mask of this embodiment is comfortable to wear, looks attractive and elegant, and greatly increase the airtightness of the face mask to therefore enhance user safety.

Referring to FIG. 8, there is shown a diagram illustrative of the 5^{th} preferred embodiment of the present invention. This embodiment is distinguished from the preceding embodiments by a technical feature as follows: an exhalation valve 50 is mounted on the mask body 10. The exhalation valve 50 enables the user to discharge moisture and heat quickly during exhalation, keep the face mask cool, discharge exhaled air quickly when taking vigorous exercise or suffering shortness of breath, reduce the resistance to exhalation greatly, and reduce the level of carbon dioxide in the user's body.

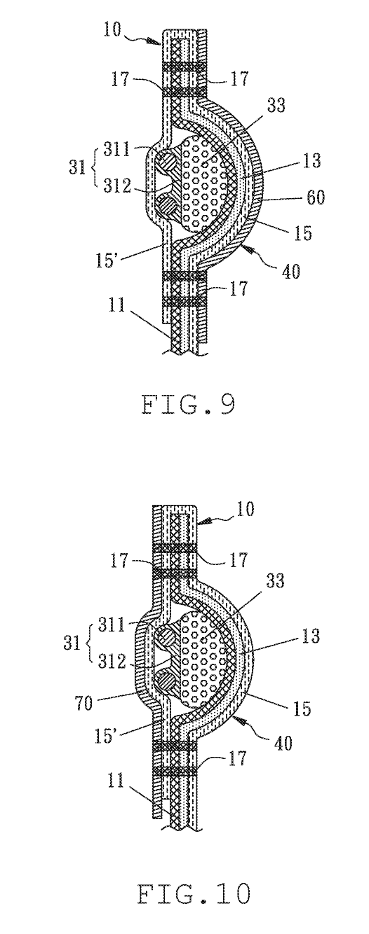

Referring to FIG. 9, there is shown a diagram illustrative of the 6^{th} preferred embodiment of the present invention. This embodiment is distinguished from the preceding embodiments by technical features as follows: an inner fogproof plate 60 is fixed to the upper side of the inner layer 15 and forms the raised portion 40; the raised portion 40 can be fitted to the contour of the face to fill the gap between the nasal bridge and each cheekbone, so as to block and prevent exhaled moisture from rising through the mask body 10, thereby precluding the fogging of eyeglasses or the blocking of vision; and the inner fogproof plate 60 is made of a gas-impermeable material, such as a thin-film, a plastic plate, or a patch.

Referring to FIG. 10, there is shown a diagram illustrative of the 7^{th} preferred embodiment of the present invention. This embodiment is distinguished from the preceding embodiments by technical features as follows: an outer fogproof plate 70 is fixed to the inner layer flap 15′; and the outer fogproof plate 70 is made of the same material as the inner fogproof plate 60. Hence, this embodiment aims to further block and prevent exhaled moisture from rising through the mask body 10, thereby precluding the fogging of eyeglasses or the blocking of vision.

Referring to FIG. 11, there is shown a diagram illustrative of the 8^{th} preferred embodiment of the present invention. This embodiment is distinguished from the preceding embodiments by technical features as follows: the outer layer 11 extends and doubles back to form an outer layer flap 11′; the outer layer flap 11′ is superimposed on the inner layer flap 15′ to enclose the nose pad 30 together with the outer layer 11; and the outer layer flap 11′ is made of the same material as the outer layer 11 and is a water repellent layer made of water repellent non-woven fabric. Hence, this embodiment aims to enhance the structural strength for enclosing the nosepiece 31 and prevent the two lateral ends of the nosepiece 31 from piercing the mask body 10, thereby enhancing user safety.

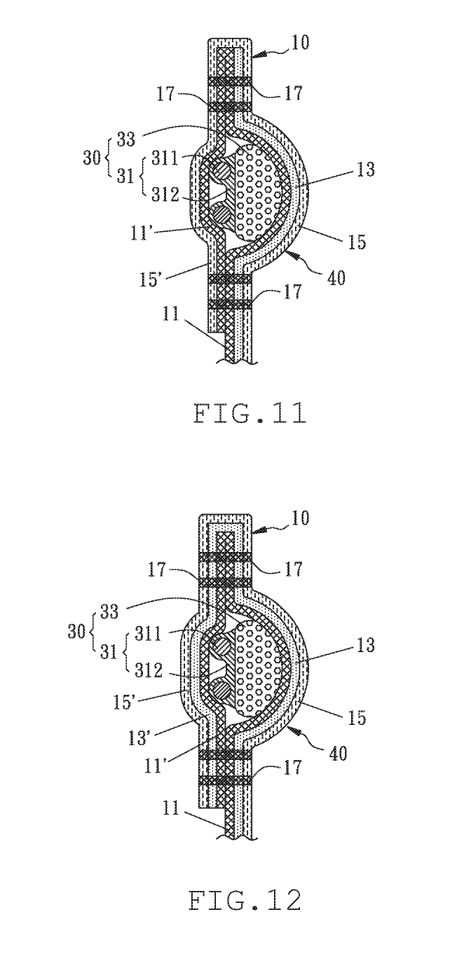

Referring to FIG. 12, there is shown a diagram illustrative of the 9^{th} preferred embodiment of the present invention. This embodiment is distinguished from the preceding embodiments by technical features as follows: the middle layer 13 extends and doubles back to form a middle layer flap 13′; the middle layer flap 13′ is sandwiched between the inner layer flap 15′ and the outer layer flap 11′ to enclose the nose pad 30 together with the outer layer 11; and the middle layer flap 13′ is made of the same material as the middle layer 13 and is a filter layer made of an electrostatic high-density non-woven. Therefore, this embodiment achieves the same functions and advantages as the preceding embodiments.

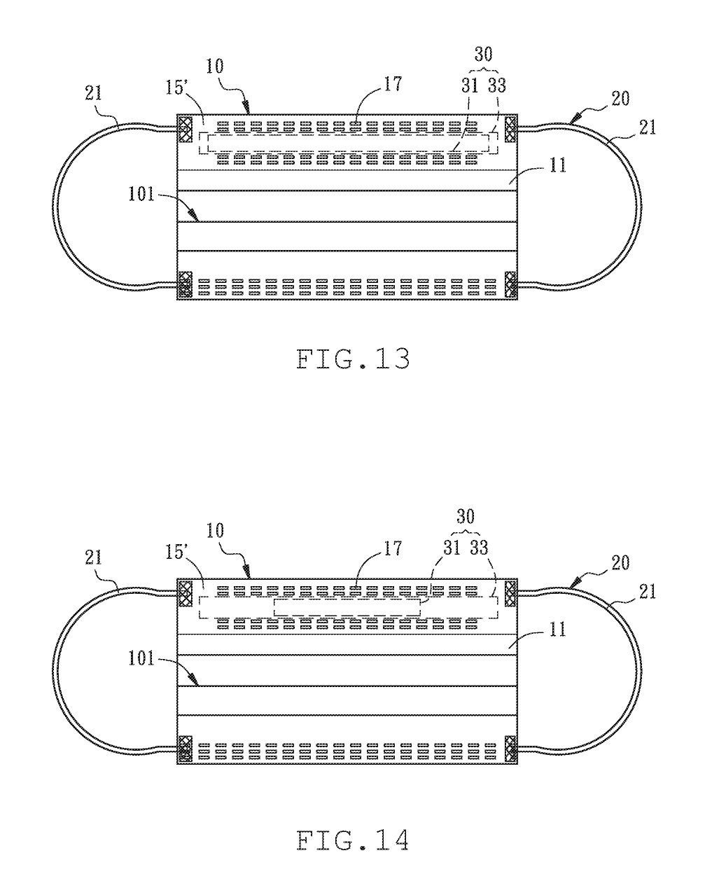

Referring to FIG. 13, there is shown a diagram illustrative of the 10^{th} preferred embodiment of the present invention. This embodiment is distinguished from the preceding embodiments by technical features as follows: the nose pad 30 is fully disposed on the upper side of the mask body 10 or extends to reach the two lateral sides of the mask body 10; and the elastomer 33 is of the same, or substantially the same, length as the nosepiece 31. Therefore, this embodiment achieves the same functions and advantages as the preceding embodiments.

Referring to FIG. 14, there is shown a diagram illustrative of the 11^{th} preferred embodiment of the present invention. This embodiment is distinguished from the preceding embodiments by technical features as follows: the elastomer 33 is of substantially the same length as the mask body 10, but the nosepiece 31 is of a length approximately half of the length of the elastomer 33. Therefore, this embodiment achieves the same functions and advantages as the preceding embodiments.

Referring to FIG. 15, there is shown a diagram illustrative of the 12^{th} preferred embodiment of the present invention. This embodiment is distinguished from the preceding embodiments by technical features as follows: an activated carbon layer 19 is sandwiched between the outer layer 11 and the middle layer 13; and the inner layer flap 15′ and the outer layer 11 jointly enclose the nose pad 30. Therefore, this embodiment is effective in adsorbing ozone and organic gases.

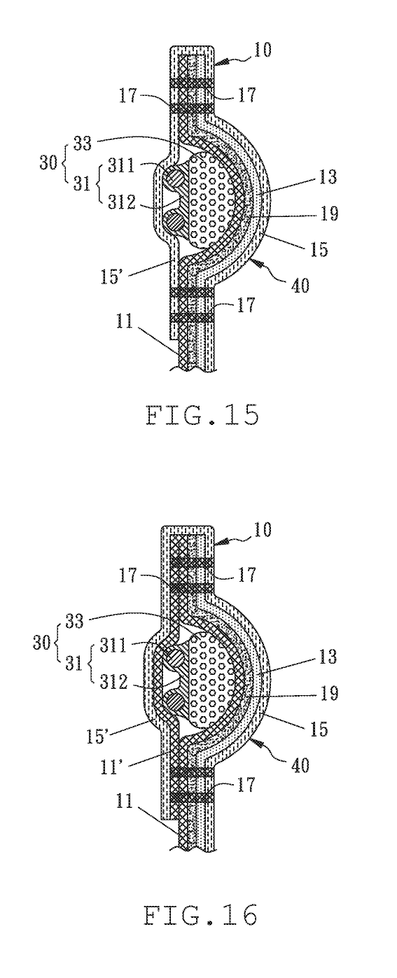

Referring to FIG. 16, there is shown a diagram illustrative of the 13^{th} preferred embodiment of the present invention. This embodiment is distinguished from the preceding embodiments by technical features as follows: an activated carbon layer 19 is sandwiched between the outer layer 11 and the middle layer 13; and the inner layer flap 15′, the outer layer flap 11′, and the outer layer 11 jointly enclose the nose pad 30. Therefore, this embodiment achieves the same functions and advantages as the preceding embodiments.

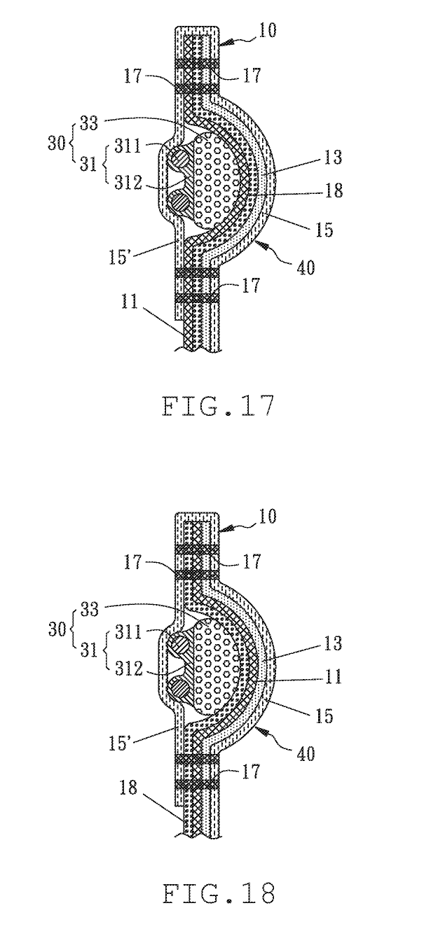

Referring to FIG. 17, there is shown a diagram illustrative of the 14^{th} preferred embodiment of the present invention. This embodiment is distinguished from the preceding embodiments by technical features as follows: an antiviral layer 18 is sandwiched between the outer layer 11 and the middle layer 13; the antiviral layer 18 is a non-woven fabric coated with an antiviral, antimicrobial material, such as nanosilver or photocatalyst, to reduce the activity of viruses and bacteria and inhibit their growth, thereby being effective in killing viruses and bacteria and preventing infections or cross infections. Therefore, this embodiment achieves the same functions and advantages as the preceding embodiments.

Referring to FIG. 18, there is shown a diagram illustrative of the 15^{th} preferred embodiment of the present invention. This embodiment is distinguished from the preceding embodiments by a technical feature as follows: the antiviral layer 18 and the outer layer 11 have their positions swapped such that the antiviral layer 18 is superimposed on the outer layer 11 and is the outermost layer of the mask body 10. Hence, when confronted with approaching viruses and bacteria, the mask body 10 reduces their activity first. Afterward, the penetrating viruses and bacteria are blocked and eventually filtered out by the mask body 10. Therefore, in this embodiment, the mask body 10 prevents pathogenic viruses and bacteria from intruding into the face mask, greatly increased filtration efficiency of the face mask.

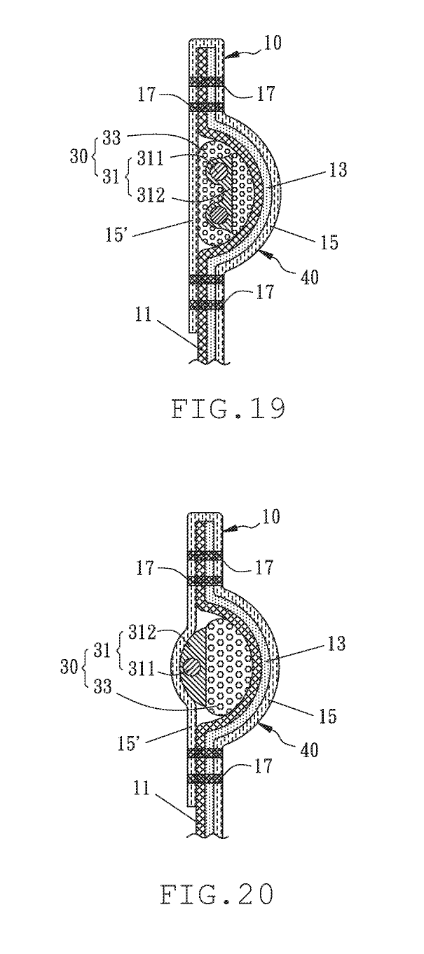

Referring to FIG. 19, there is shown a diagram illustrative of the 16^{th} preferred embodiment of the present invention. This embodiment is distinguished from the preceding embodiments by a technical feature as follows: the nose pad 30 has the nosepiece 31 embedded in the elastomer 33. Hence, the structural strength of the nose pad 30 is increased (to prevent it from separating), and user safety is enhanced (by preventing the two lateral ends of the nosepiece 31 from piercing the face mask.)

Referring to FIG. 20, there is shown a diagram illustrative of the 17^{th} preferred embodiment of the present invention. This embodiment is distinguished from the preceding embodiments by technical features as follows: the iron wire 311 is a single iron wire which can be thickened, or the enclosure volume of the plastic element 312 can be increased, so as to enhance the structural strength of the nose pad 30. Therefore, this embodiment achieves the same functions and advantages as the preceding embodiments.

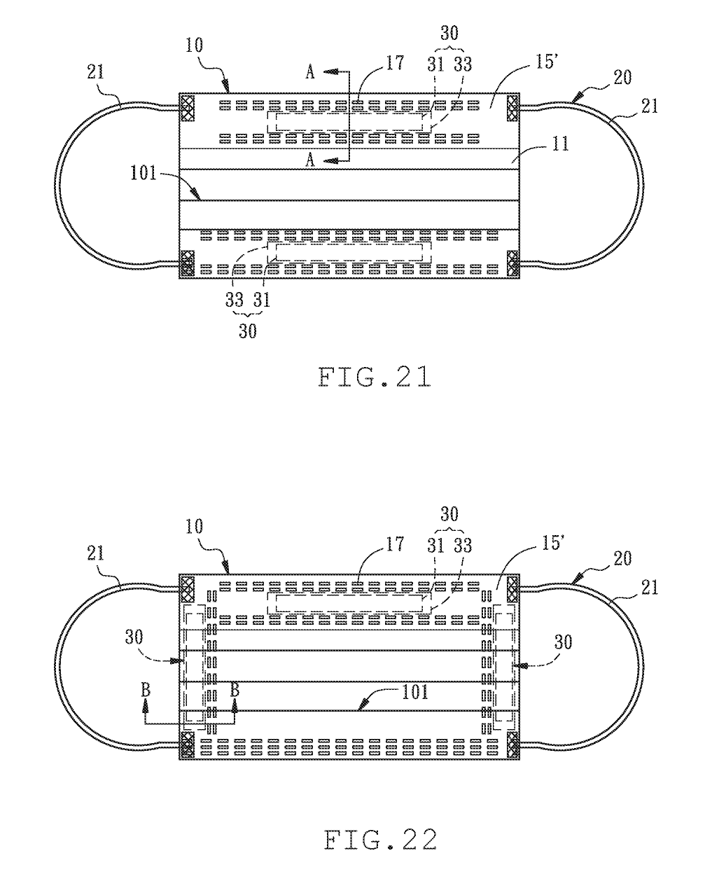

Referring to FIG. 21, there is shown a diagram illustrative of the 18^{th} preferred embodiment of the present invention. This embodiment is distinguished from the preceding embodiments by a technical feature as follows: another nose pad 30 or a tightfitting pad is disposed at the lower side of the mask body 10. Therefore, this embodiment achieves the same functions and advantages as the preceding embodiments.

Referring to FIG. 22, there is shown a diagram illustrative of the 19^{th} preferred embodiment of the present invention. This embodiment is distinguished from the preceding embodiments by a technical feature as follows: two nose pads 30 or tightfitting pads flank the mask body 10 respectively. Therefore, this embodiment achieves the same functions and advantages as the preceding embodiments.

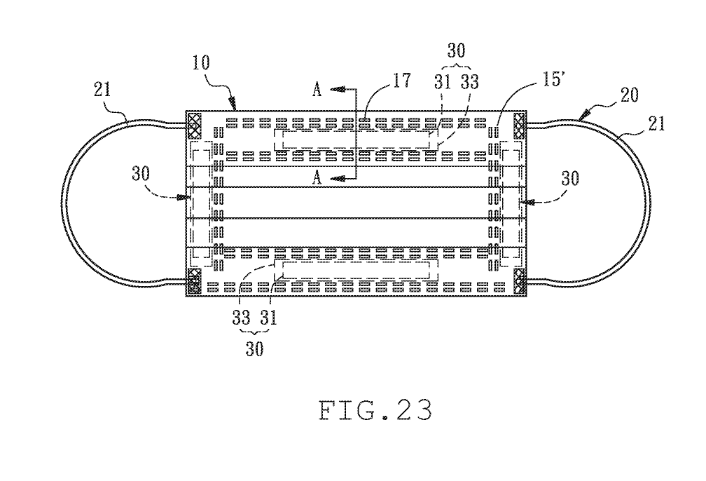

Referring to FIG. 23, there is shown a diagram illustrative of the 20^{th} preferred embodiment of the present invention. This embodiment is distinguished from the preceding embodiments by a technical feature as follows: three nose pads 30 or tightfitting pads are disposed at the two lateral sides and the lower side of the mask body 10 respectively. Therefore, this embodiment achieves the same functions and advantages as the preceding embodiments.

In conclusion, compared with the prior art, the present invention has major advantages as follows: the raised portion 40 is formed at the upper side of the mask body 10 to fill the gap between the nasal bridge and each cheekbone, increase the airtightness of the nasal portion of the face mask greatly, prevent the user's eyeglasses from fogging, and form an enlarged space inside the face mask to not only enable the user to breathe smoothly and speak naturally, but also reduce the resistance to respiration greatly.

The other advantages of the present invention are as follows: the mask body 10 further has therein the activated carbon layer 19 or the antiviral layer 18. Activated carbon eliminates ozone and organic gases efficiently. The antiviral layer 18 reduces the activity of viruses and bacteria and inhibits their growth, thereby being effective in killing viruses and bacteria and preventing infections or cross infections.

What presented above are the feasible preferred embodiments of the present invention. However, the preferred embodiments are not restrictive of the claims of the present invention. All equivalent structural changes made to the preferred embodiments in accordance with the disclosure contained in the drawings and specification of the present invention should be deemed falling within the scope of the claims of the present invention.

1. A face mask having an embedded nose pad, comprising: a mask body having an outer layer, a middle layer, and an inner layer sequentially; and a nose pad disposed on the outer layer, wherein the inner layer extends and doubles back to form an inner layer flap, and the nose pad is enclosed by the inner layer flap and the outer layer jointly, allowing a raised portion to be formed on the mask body and corresponding in position to the nose pad.

2. The face mask having an embedded nose pad according to claim 1, further comprising a plurality of fixing portions arranged along an edge of the raised portion and adapted to fix the inner layer flap, the outer layer, the middle layer, and the inner layer in place.

3. The face mask having an embedded nose pad according to claim 2, wherein the middle layer is a filter layer, and the raised portion is formed on the filter layer.

4. The face mask having an embedded nose pad according to claim 3, wherein the outer layer extends and doubles back to form an outer layer flap such that the outer layer flap is superimposed on the inner layer flap to enclose the nose pad together with the outer layer.

5. The face mask having an embedded nose pad according to claim 4, wherein the mask body comprises two vertical folds which flank the nose pad respectively.

6. The face mask having an embedded nose pad according to claim 1, further comprising two bending parts extending from two lateral sides of the mask body respectively, and doubling back to get fixed two ends to the mask body.

7. The face mask having an embedded nose pad according to claim 1, further comprising an inner fogproof plate fixed to the inner layer and having the raised portion.

8. The face mask having an embedded nose pad according to claim 1, further comprising an exhalation valve mounted on the mask body.

9. The face mask having an embedded nose pad according to claim 1, further comprising an activated carbon layer sandwiched between the outer layer and the middle layer.

10. The face mask having an embedded nose pad according to claim 1, further comprising an antiviral layer superimposed on the outer layer or sandwiched between the outer layer and the middle layer.

11. The face mask having an embedded nose pad according to claim 1, wherein the nose pad is a foam or a combination of a nosepiece and a foam.
